(19) United States
(12) Patent Application Publication
(10) Pub. No.: US 2014/0059464 A1
(43) Pub. Date: Feb. 27, 2014

(54) MOBILE DEVICE WITH GRAPHICAL USER INTERFACE FOR MONITORING AN OPERATION SCHEDULE OF A BUILDING AUTOMATION SYSTEM

(71) Applicant: TRANE INTERNATIONAL INC., Piscataway, NJ (US)

(72) Inventors: Susan M. Mairs, St. Paul, MN (US); Bryan George Kinney, Stillwater, MN (US); Kimberly Hayman, Minneapolis, MN (US); Melissa Rose Schumann, Brooklyn Park, MN (US); Rachel Michael Nilsson, Minneapolis, MN (US); Jacob Larson, Minneapolis, MN (US)

(73) Assignee: TRANE INTERNATIONAL INC., Piscataway, NJ (US)

(21) Appl. No.: 13/972,265

(22) Filed: Aug. 21, 2013

Related U.S. Application Data
(60) Provisional application No. 61/691,551, filed on Aug. 21, 2012.

(51) Int. Cl. G06F 3/0481; G06F 3/0482; G06F 3/0485

(52) U.S. Cl. CPC G06F 3/04817; G06F 3/0485; G06F 3/0482
USPC 715/771

(57) ABSTRACT

A mobile device with a graphical user interface for remotely monitoring and/or remotely interacting with a configurable building automation systems (BAS). In particular, the mobile device receives operation schedule data of the BAS from the BAS, the graphical user interface displays the operation schedule data on the mobile device, and the graphical user interface allows a user to monitor the operation schedule of the BAS.

### FIELD

This disclosure generally relates to a mobile device with a graphical user interface for remotely monitoring and/or operating a building automation system.

### BACKGROUND

A Building automation system (BAS) is used to coordinate, manage, and automate control of diverse environmental, physical, and electrical building subsystems, particularly HVAC and climate control, but also including security, lighting, power, and the like.

Hardwiring and programming of a BAS can create a robust fixed system customized for a particular installation. However, monitoring and maintenance of the BAS are still generally labor-intensive tasks that vary with each system implementation. In a common scenario, a user managing a building site must be at the location of the BAS and use a computer or other device hardwired to the BAS. If there is an issue with how the BAS is operating, the user managing the building site must physically be at the BAS to monitor the issue and to resolve the issue. If the user is not physically at the BAS location and receives notification that there is an issue with the BAS, generally, the user must physically go to the BAS location to monitor and to resolve the issue.

### SUMMARY

The embodiments described herein relate to a mobile device for interacting with a BAS remotely. Preferred embodiment relate to the mobile device for interacting with HVAC (heating, ventilation, and air conditioning) related aspects of the BAS.

The mobile device comprises a processor in communication with a memory, a network interface, and a touchscreen. The processor executes instructions for a graphical user interface (GUI) and displays the GUI on the touchscreen. The GUI includes a screen portion (or screen) and a navigation bar. The navigation bar includes a plurality of icons, each of the icons being associated with an interactive screen. When a user selects one of the icons of the navigation bar by touching the touchscreen, the selection is detected by the processor and the processor processes the associated interactive screen to be displayed in the touchscreen. The processor is configured to receive data in real time from the BAS via the network interface. Data received in real time includes operation schedule of the BAS.

An embodiment of the mobile device includes the GUI with an interactive screen displayed in the screen, wherein the interactive screen includes a scrollable time view. A portion of the time view has a first operation data displayed in a first color. An embodiment of the mobile device includes the GUI with another portion of the time view having a second operation data displayed in a second color.

An embodiment of the mobile device includes a GUI showing a calendar, (i.e. a calendar GUI) wherein the calendar includes a month view including each date of the month, wherein one or more of the dates having a first operation data is displayed in a first color. Another embodiment of the mobile device includes the calendar GUI having one or more of the dates of the month view with a second operation data displayed in a second color.

### BRIEF DESCRIPTION OF THE DRAWINGS

Referring now to the drawings in which like reference numbers represent corresponding parts throughout.

FIG. 1 is a cartoon diagram of a building automation system (BAS) connected to a mobile device according to one embodiment.

FIG. 2 is a schematic diagram of a mobile device according to one embodiment.

FIG. 3 is a graphical user interface diagram for a mobile device according to an embodiment.

FIG. 4 is a graphical user interface diagram for a mobile device according to an embodiment.

### DETAILED DESCRIPTION

The embodiments described herein are directed to a mobile device with a GUI for remotely monitoring and/or operating a building automation system.

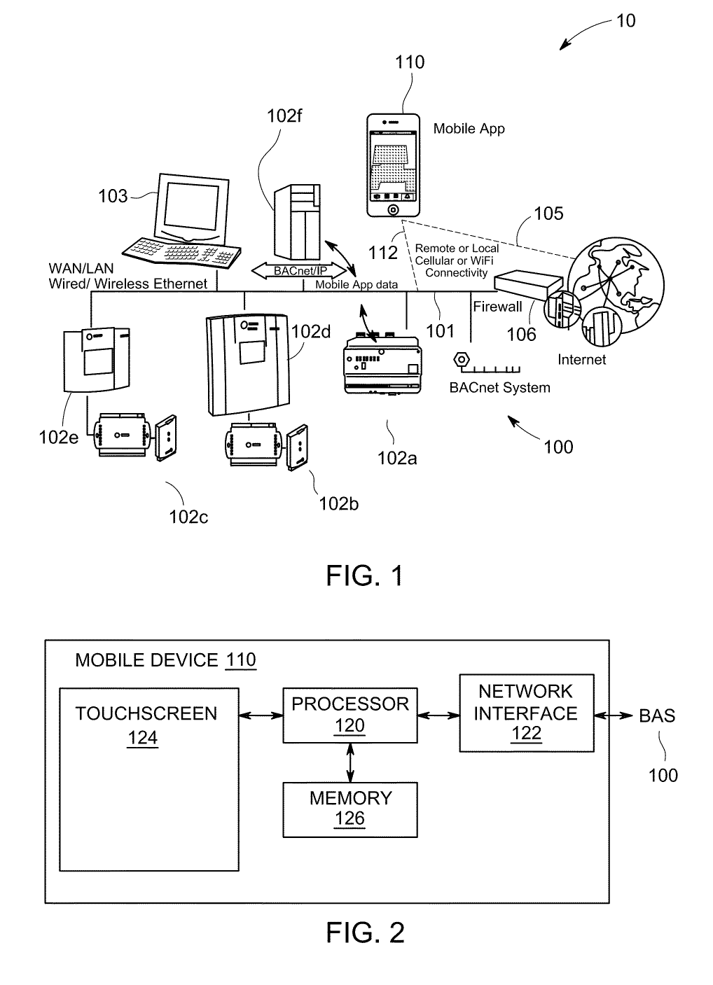

FIG. 1 shows a cartoon of a system 10 including an embodiment of a BAS 100 that includes a hardwired network 101 that uses a communication standard or protocol to link various subsystems, such as a system control unit 102a, a unit control device 102b, 102c, and/or other devices 102d, 102e, 102f, and provide a system-wide user access and control from a computer 103 hardwired to the network. The BAS 100 is connected to the internet 105, and includes a network security device 106, such as a firewall, that secures and protects the BAS 100 from unwanted intrusion via the internet 105.

The embodiment includes a mobile device 110 connectable to the BAS 100 via the internet 105, accessing the BAS 100 through the network security device 106. The mobile device 110 can connect to the BAS 100 via a local wireless connection 112. The local wireless connection 112 can be established behind the network security device 106, so that the mobile device 110 can connect to one or more of the components or devices 102a-f of the BAS 100 without requiring the communication between the mobile device 110 and the BAS 100 to go through the network security device 106.

The mobile device 110 can connect to the BAS 100 via the internet 105 using cellular, 3G, 4G, or other wireless communication protocol. The mobile device 110 can connect to the BAS 100 via the local wireless connection 112 using WiFi, bluetooth, or other wireless communication protocol. The mobile device 110 can connect to the BAS 100 using a combination of the internet 105 and local wireless connection 112.

FIG. 2 shows an illustrated schematic diagram of an embodiment of a mobile device 110. The mobile device 110 includes a processor 120 in communication with a network interface 122 and a touchscreen 124. The touchscreen 124 is a combination display and a human-computer interface device. The touchscreen 124 displays images as instructed by the processor 120. The touchscreen 124 can detect user input via touch or contact by a human finger or a stylus device, and sends the input to the processor 120. A memory 126 is in communication with the processor 120, and the memory 126 stores instructions for an operating system that is executed by the processor 120. The memory 126 can also store instructions for a computer program that is executed by the processor 120. The computer program includes a GUI for remote operation of a BAS 100.

Embodiments of the mobile device 110 include, but are not limited to, a smartphone, an iPhone, an iPad, an iPod, an Android phone, an Android tablet, a Windows phone, a Windows tablet, etc. Embodiments of the operating system include, but are not limited to, iOS, Android OS (e.g. Donut, Eclair, Gingerbread, Honeycomb, Ice Cream Sandwich, Jelly Bean, etc.), Windows, etc. Embodiments of the computer program include, but are not limited to, software for mobile device 110s commonly called an “App” or “Mobile App,” a script written in a scripting language, etc.

According to an embodiment, a GUI is displayed on the touchscreen 124 when the computer program instructions are executed by the processor 120, the GUI displays information to a user and also provides various input points for the user to interact with the GUI so that the user is allowed to provide input, such as operational commands or data request, which is sent to the processor 120. The processor 120 can then process the input according to the computer program instructions being executed and can communicate with the memory 126 and/or network interface 122 to provide data to be displayed on the touchscreen 124.

An embodiment of a computer program is stored on a computer readable medium, wherein the computer program includes computer readable instructions that can be executed by a processor 120 to display a GUI on a touchscreen 124 configured to provide data output on the touchscreen 124, and at the same time, receive operational input for remotely monitoring and/or operating a BAS 100. The data output provided can be in real time, as the data is received from the BAS 100 to the mobile device 110 via the network interface 122 of the mobile device 110.

Accordingly, a user of the mobile device 110 can be located almost anywhere and monitor and/or interact with the operation of the BAS 100, as long as the mobile device 110 can wirelessly connect to the BAS 100.

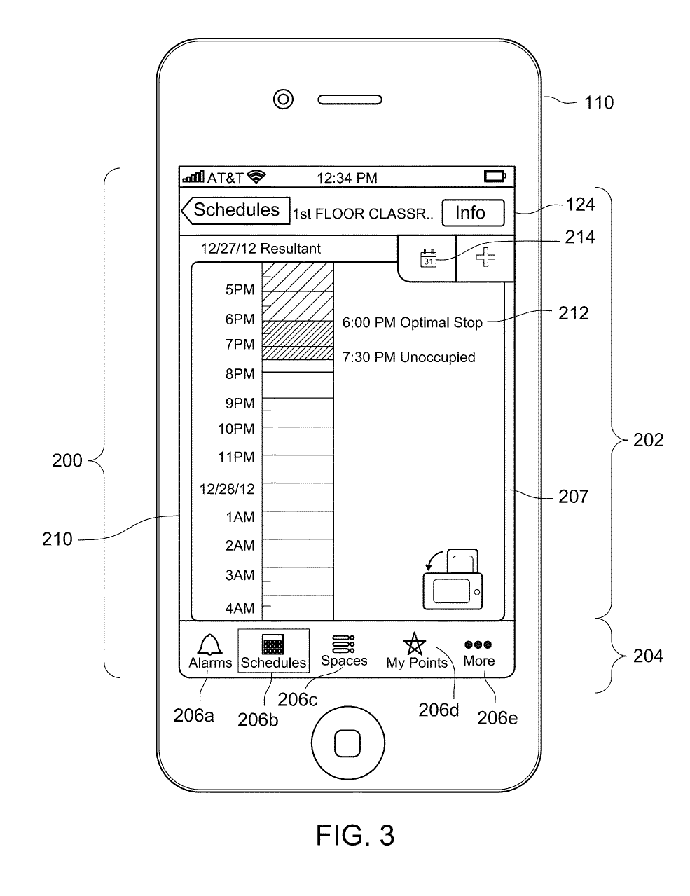

FIG. 3 shows an illustration of an embodiment of a mobile device 110 for remote operation and/or monitoring of a BAS. The mobile device 110 has a touchscreen 124 displaying a GUI 200 which includes a screen portion 202 (or screen) and a navigation bar portion (or navigation bar) 204. The navigation bar 204 includes a plurality of icons 206a, 206b, 206c, 206d, 206e, wherein each of the icons 206a-e are associated with an interactive screen, so that when one of the icons is selected by touching the touchscreen 124, the interactive screen associated with the selected icon is displayed in the screen 202 of the GUI 200. FIG. 3 shows the icon 206b having been selected, and the interactive screen 207 that is associated with the icon 206b being displayed in the screen 202 of the GUI 200 on the touchscreen 124 of the mobile device 110.

It is to be understood that the term icon describes a computer generated graphic image that is used in the GUI 200 for displaying information and/or for allowing a human to interact with the mobile device 110.

The interactive screen 207 includes an operation schedule of the BAS displayed graphically and interactively. An example of an operation schedule of the BAS is described as follows. A BAS controls various conditions of a room in a building, wherein it is known that, generally, the room is occupied by a person from 8:00 A.M. to 5:00 P.M. on Mondays to Friday. In the other times, the room is not occupied. Further, during certain holidays, the room is unoccupied. Thus, the BAS and/or a thing that is associated with the BAS (such as, but is not limited to, one or more of a component, a device, a unit, a system, a subsystem, a controller, a space, a building, a room, etc. The component may be the condenser or the evaporator, the unit may be a chiller, the system can be a HVAC system or circuit, the subsystem can be a control system for the HVAC system.) can be set (i.e. programmed) to operate differently or in a same manner based on time data, i.e. the day of the week, the time of the day, and certain holidays. Further, a thing that is associated with the BAS can be set to operate differently or in a same manner based on the time data.

For example, when the room is known to be generally occupied, the BAS can be set to turn on the lights in the room, allow HVAC to provide air to the room, and set the temperature of the room to 75° F. Further, for example, when the room is unoccupied, the BAS can be set to turn off the lights in the room, stop providing air from the HVAC, and set the temperature of the room to 85° F. (if it is summer) or 55° F. (if it is winter). Other conditions, such as water temperature, power, humidity level, air flow rate, etc. can be set based on the time data.

This “setting” or “programming” of how the BAS is to operate based on the time data is an example of the operation schedule of the BAS. The operation schedule can provide efficient use of resources, for example, to use power to provide desired conditions of a room or a building only when those spaces are expected to be in use by a person. Further, the operation schedule of the BAS can change based on a person or the people who use the room or the building.

The GUI 200 of the mobile device 110 displays in the screen 202 the operation schedule of the BAS, in real time. The operation schedule includes time data 210, which can include year, month, date, time, or a combination thereof For example, the time data 210 can be displayed in a linear format, as shown in FIG. 3. An operation data 212, that is information of how the BAS will operate at particular times, is also shown in the screen 202 of the GUI 200. The interactive screen 207 allows vertical scrolling of the operation schedule by a user touching the touchscreen 124.

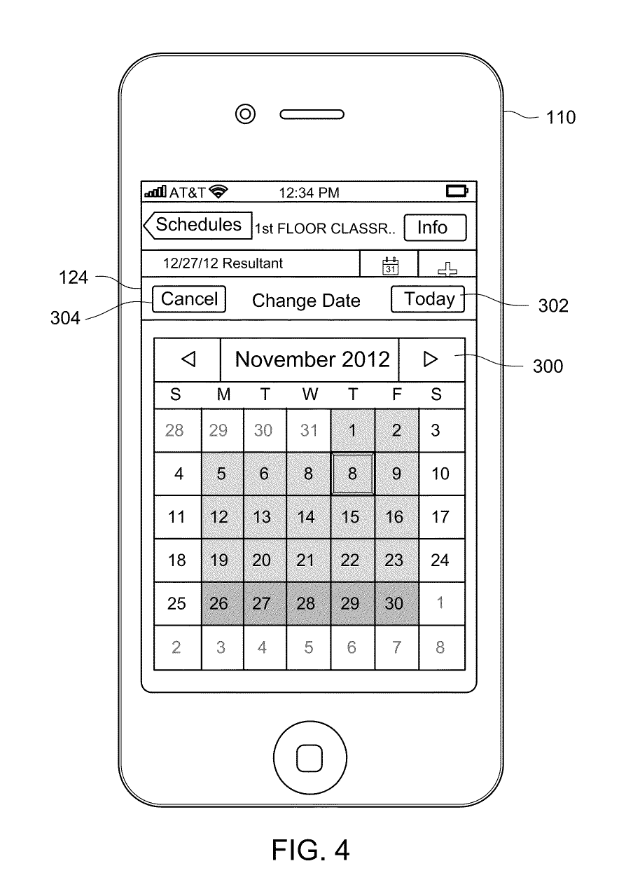

The GUI 200 also includes a calendar icon 214 in the screen 202. The calendar icon 214, when selected by a user by touching the touchscreen 124, displays in the touchscreen 124 a calendar window, as shown in FIG. 4.

FIG. 4 shows the calendar GUI 300 displayed in the touchscreen 124 of the mobile device 110. The calendar GUI 300 displays a month view showing each date of the month. Each date of the month can be selected by a user by touching the touchscreen 124, and when a date is selected by a user, the calendar GUI 300 becomes hidden from view (i.e. is no longer displayed in the touchscreen 124) and the GUI according to the one shown in FIG. 3 is displayed, but the data displayed in the GUI is of the date selected from the calendar GUI 300.

Further, FIG. 4 shows a TODAY icon 302, which when selected by a user by touching the touchscreen 124, the calendar GUI 300 becomes hidden from view (i.e. is no longer displayed in the touchscreen 124) and the GUI according to the one shown in FIG. 3 is displayed, but the data displayed in the GUI is today's (or the present day set according to the processor and/or memory of the mobile device 110) operation schedule.

FIG. 4 shows a CANCEL icon 304, which when selected by a user by touching the touchscreen 124, the calendar GUI 300 becomes hidden from view (i.e. is no longer displayed in the touchscreen 124) and the GUI according to the one shown in FIG. 3 is displayed, but the data displayed in the GUI is for the day that was previously shown in the GUI before the calendar icon of the GUI was selected.

Further, the calendar GUI 300 can display each date of the month by a color based on the operation schedule of the BAS for that date. For example, FIG. 4 shows that, for November 1 to 25 of 2012, the BAS is scheduled to operate as set. Thus these dates in the calendar GUI 300 are shown in a first color. FIG. 4 shows that, for November 26-30, 2012, the BAS is set to operate differently from the other dates in that month. Accordingly these dates in the calendar GUI 300 are shown in a second color. Accordingly, the BAS can have a first operation schedule, that is generally the “normal” schedule, and various exceptions can be made to that “normal” schedule. These exceptions, that would vary from the “normal” scheduled operation of the BAS can be displayed in a different color from the color of the “normal” schedule displayed. Thus, advantageously, a user of the mobile device 110 can monitor the operation schedule of the BAS and see the exceptions from the “normal” schedule quickly and easily, and in real time. Thus, if the operation schedule of the BAS is changed, the user who monitors the operation schedule can see and/or recognize that change immediately due to the change in the colors of times and/or dates changing in the GUI.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A mobile device for remote operation of a building automation system, comprising:
a processor in communication with a network interface and a touchscreen;
the processor executing instructions for a graphical user interface and displaying the graphical user interface on the touchscreen,
the graphical user interface is configured to receive operational instructions via the touchscreen, relay the operational instructions to the processor, the processor is configured to send the operational instructions to the building automation system via a transmission from the network interface,
the graphical user interface includes a screen and a navigation bar, the navigation bar includes a plurality of icons, each of the icons is associated with an interactive screen, wherein a selection of one of the icons by touching the touchscreen is detectable by the processor to display on the touchscreen the interactive screen associated with the one of the icons, and
the interactive screen includes a scrollable time view, wherein a portion of the time view has a first operation data displayed in a first color.

2. The mobile device according to claim 1, wherein another portion of the time view has a second operation data displayed in a second color.

3. A mobile device for remote operation of a building automation system, comprising:
a processor in communication with a network interface and a touchscreen,
the processor executing instructions for a graphical user interface and displaying the graphical user interface on the touchscreen,
the graphical user interface is configured to receive operational instructions via the touchscreen, relay the operational instructions to the processor, the processor is configured to send the operational instructions to the building automation system via a transmission from the network interface, and
the graphical user interface includes an interactive screen includes a calendar, wherein the calendar includes a month view including each date of the month, wherein one or more of the dates having a first operation data is displayed in a first color.

4. The mobile device according to claim 3, wherein one or more of the dates of the month view has a second operation data displayed in a second color.
